(19) United States
(12) Patent Application Publication
(10) Pub. No.: US 2022/0241932 A1
(43) Pub. Date: Aug. 4, 2022

(54) APPARATUS FOR USE IN CLAMPING WORKPIECES AND RETAINING POWER TOOL APPARATUS

(71) Applicant: Power Box AG, Zug (CH)

(72) Inventor: Louis Street, Somerset (GB)

(73) Assignee: Power Box AG, Zug (CH)

(21) Appl. No.: 17/616,214

(22) PCT Filed: Jun. 4, 2020
(86) PCT No.: PCT/EP2020/065521

§ 371 Date: Dec. 3, 2021

(30) Foreign Application Priority Data
Jun. 6, 2019 (GB) 1908092.8

(51) Int. Cl. B25B 1/24; B25H 1/06; B25H 1/10

(52) U.S. Cl. CPC B25B 1/2484; B25H 1/10; B25H 1/06

(57) ABSTRACT

The invention relates to apparatus and method for use in the performance of work on a workpiece, said apparatus including a plurality of legs depending from a body so that, when the legs are in an in-use position, the body is supported at a fixed distance from a support surface with which the legs contact. The apparatus, in a first mode of use, has a clamping function to allow the workpiece to be clamped with the body and said apparatus further includes one or more support means, in one embodiment in the form of support arms, which are engageable with the body so as to define a support for the location and engagement of a power tool which, when engaged, is usable to perform a work operation on said workpiece with the apparatus being provided in a second mode.

The invention relates to apparatus which is for use for a range of purposes, all directed towards performing work on a workpiece such as an item of wood, metal, plastic or the like.

In particular, the invention is directed towards apparatus which allows the workpiece on which the work is to be performed to be retained in a clamped, fixed, position and, alternatively, and selectively, to allow an item of apparatus which is to be used to perform the work on the said workpiece, to be held in a fixed, clamped position.

The provision of apparatus which can be adjusted to allow a clamping force to be applied to a workpiece so as to allow the said workpiece to be held in a fixed position during the performance of a work operation, such as sanding, cutting, polishing or the like is well-known and the Applicant, in their co-pending application GB2549612 defines one form of this apparatus in which there is provided a stand, a fixed clamping jaw, and a moveable clamping jaw which can be moved towards and away from the fixed clamping jaw so as to define a space of a particular size suited to the particular item or workpiece which is to be clamped in position at that time. The position of the moveable clamping jaw can be adjusted by the user so as to contact the workpiece and a further movement in the same direction, applies a clamping force onto the workpiece and the fixed jaw so as to clamp the workpiece in position securely in the apparatus whilst the working action is performed. The position of the moveable jaw can be adjusted between and within a range of possible positions.

It is also known that with regard to power tools which are to be used to perform a working operation on a workpiece, it is necessary, for safety purposes and also for accuracy of use, for the power tool to be located in a fixed position during use of the same and for the workpiece position with respect to the power tool to then be moveable during the performance of the working operation, such as, for example sanding, or alternatively, for the workpiece to be moveable with respect to the power tool to a particular position and for the power tool operation to then be performed such as, for example, to cut through the workpiece at a particular location. In order to achieve this, then the user typically has to, at the very least, locate the power tool on a base and retain, manually, the power tool in the fixed position on the base but this still has the risk of movement of the power tool during use. Another possibility is to secure the power tool to a support in a fixed position during the working operation.

The problems with these known forms of apparatus as described above, is that commonly, the user of the apparatus who wishes to perform the working operation on the workpiece, only has a relatively confined space available, such as, for example a shed, garage, outhouse or the like in which the work on the workpiece is to be performed and, due to the dust and debris which is created during the working operation, it is desired to perform the work outside of the normal living area of the premises. Even in other environments, such as industrial and commercial environments, where there may be more space available, there are still concerns about the cost of having to purchase different forms of apparatus for different purposes, especially when the apparatus, once purchased may only be sporadically used and, for the rest of the time, is either stored or takes up space. Indeed, in many instances, and particularly when DIY work is undertaken, while the person appreciates the advantages of the apparatus, they either do not use or purchase the same due to the lack of available space and the relatively low usage of the same.

The aim of the present invention is therefore to provide apparatus which can be used for an increased range of functions by allowing the selective adaptation of the apparatus to be achieved in a manner which thereby allows the same item of apparatus to be used indifferent modes and thereby avoid the need for additional items of apparatus to be purchased and accommodated. A further aim is to improve the safety of the user by ensuring that each of the functions which can be performed on the apparatus can be performed in a safer and more reliable manner than if the apparatus was not provided. A further aim is to provide the apparatus in a form which allows a more accurate use of the power tool and hence performance of the work on the workpiece to be achieved.

In a first aspect of the invention, there is provided apparatus for use in the performance of work on a workpiece, said apparatus including a plurality of legs depending from a body so that, the body is supported at a fixed distance from a support surface with which the legs contact, said body elongate inform and including a moveable jaw so that, in a first mode of use of the apparatus, said moveable jaw is selectively positioned along said body to define a space between the said moveable jaw and another jaw at or adjacent to one end of the said body and into which space the workpiece is received so as to be clamped in position between said jaws and wherein said apparatus includes one or more support means and said apparatus is adaptable to a second mode in which said one or more support means are engaged with the said body so as to define a support for the location of a power tool which, when located with the support means is supported in a fixed position so as to be used to perform a work operation on said workpiece.

In one embodiment the said one or more support means are selectively engageable with the body of the apparatus so as to allow the same, when placed in position with the body, to support the power tool thereon and removed from the body when the same are not required to be used.

In one embodiment the apparatus is operable to clamp the workpiece when the said at least one support means are removed and/or when the support means are in position with respect to the body.

In one embodiment the one or more support means are provided in the form of first and second support arms locatable on the body at spaced apart locations along a longitudinal axis of the said body. Typically, the support arms are locatable on the body at spaced locations along the longitudinal axis of the said body.

Typically, the particular spaced locations are selectable by the user and the selection is made in accordance with the position of engagement portions formed on the power tool which are engaged with the said support arms.

In one embodiment, the engagement means on the power tool are a series of apertures for the receipt of engagement means, such as bolts, which pass through the said apertures and into location with the support arms. In one embodiment, the apertures in the power tool and/or the support arms, are slotted so as to allow the same to be range taking and thereby allow different sizes of power tools to be engaged using the support arms via the slotted arrangement of the apertures and typically also range taking in terms of the selective spacing of the support arms and at which selected locations the support arms can be engaged with the body of the apparatus.

In one embodiment, each of the support arms includes a first retaining portion which is provided to locate and engage with a first part of the body and a second retaining portion provided to engage with a second part of the body. In one embodiment said first and second retaining portions define a recessed part of the support arm in which part of the body and/or track are located when the support arm is engaged therewith.

In one embodiment the said first and second parts are first and second opposing side walls of the body.

Typically, the support arms include a user-actuable portion which, when operated, further increases the retaining force of the support arm on the said body and typically, the user actuable portion is operated by the user once they have selected the appropriate position of the support arm on the body so as to secure the support arm and power tool connected thereto in position on the body.

Typically, the power tool is engaged with the support arms and then the support arms are engaged with the body of the apparatus.

Typically the movable jaw is mounted on a track formed in the body and is slidingly movable along said body and the other jaw is provided in affixed position on said body.

In one embodiment, in order to operate the clamping means of the apparatus, a foot pedal lever assembly is provided such that when the foot pedal is pivotally moved by the user, the said moveable clamping jaw is advanced towards the fixed clamping jaw and a release means is provided such then when the release means is operated, the moveable clamping means can be moved manually away from the fixed clamping jaw.

Typically the power tool can be any power tool which is designed to be used in a fixed or stationary position such as a mitre saw, bench top power tool, sander tool, sharpener tool or the like.

In a further aspect of the invention there is provided a method for performing work on a workpiece using support apparatus to secure in position either the workpiece on which the work is to be performed or a power tool which is to perform the work on the workpiece, said support apparatus including a body portion, a moveable jaw which is moveable in relation to another jaw at or adjacent to an end of the body portion, one or more support means for the selective engagement of a power tool thereon and wherein said method includes the step of adapting the apparatus between a first mode of operation in which the workpiece is clamped in position between said jaws by the selective movement by the user of the moveable jaw towards and away from the other jaw to define a space therebetween in which the workpiece can be positioned and advancing the moveable jaw towards the other jaw to exert a clamping force on the workpiece and a second mode of operation, by locating the power tool with one or more said support means prior to or after locating said support means on said body, so as to engage the support means to the body and the power tool in a fixed position with respect to said body to allow the power tool to then be operated to perform work on a workpiece.

Typically, the support means includes at least first and second support arms and locating the first support arm at a first location on the said body and the second support arm at a second location on the said body, spaced from the first support arm.

Specific embodiments of the invention are now described with reference to the accompanying drawings wherein:

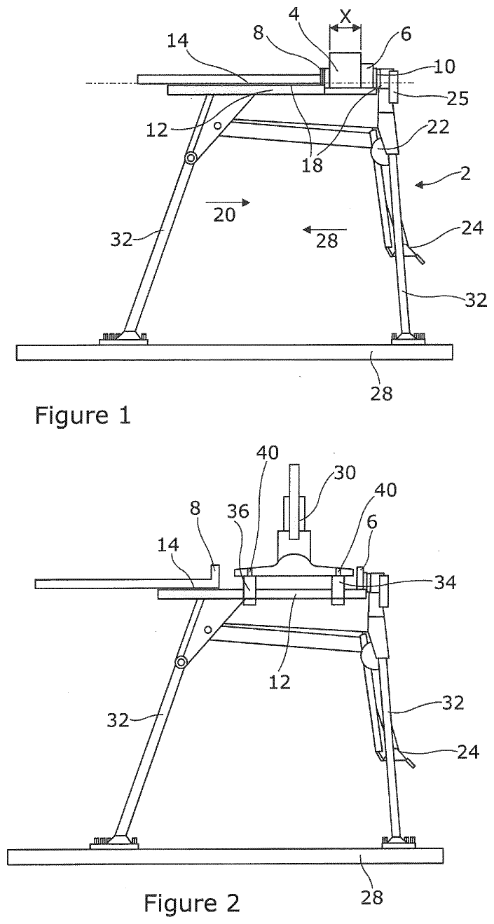

FIG. 1 illustrates apparatus in accordance with the invention in a first mode to perform a clamping operation on a workpiece.

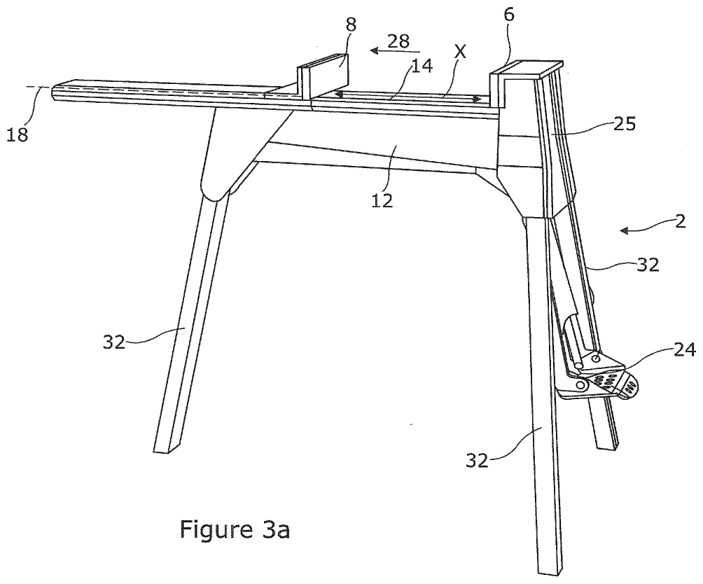

FIG. 2 illustrates apparatus in accordance with the invention in a second mode to secure a power tool in a fixed position with said apparatus.

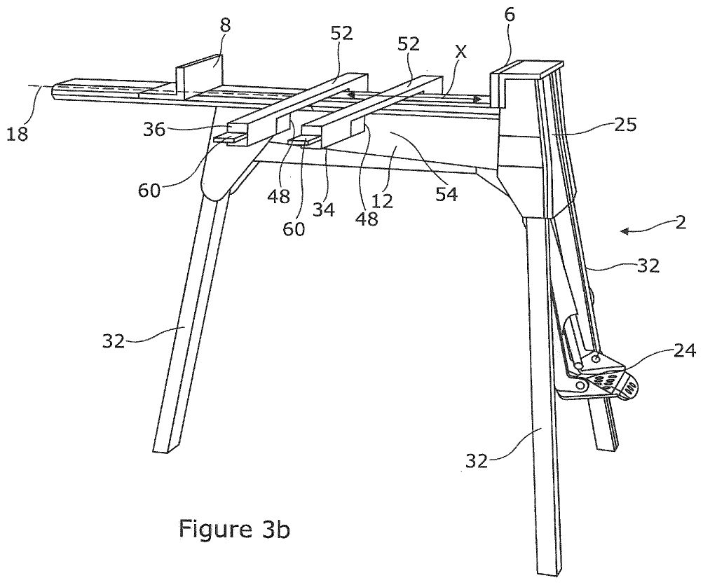

FIGS. 3a-b illustrate steps of adaptation of the apparatus in accordance with one embodiment of the invention between the first and second modes of operation; and

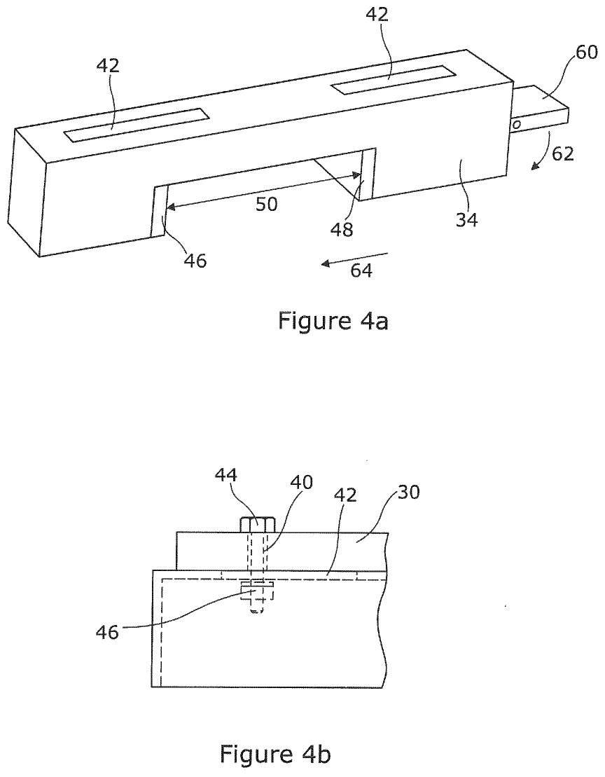

FIGS. 4a and b illustrate a support arm in accordance with one embodiment of the invention.

Referring firstly to FIG. 1, there is illustrated apparatus 2 in accordance with an embodiment of the invention. The apparatus is shown in a first mode of operation in FIG. 1 in which the same is used to clamp a workpiece 4 in position between a fixed jaw 6 and a moveable jaw 8. The fixed jaw is located at one end 10 of a body 12 of the apparatus and the moveable jaw is mounted to be moveable along a track 14 located in the body and along a longitudinal axis 18 of the body so as to allow the space X between the fixed jaw and the moveable jaw to be adjusted to suit the size of the workpiece 4 which is to be located between the said jaws. Typically, once the space X substantially matches the dimension of the workpiece which is to be clamped in position, the exertion of a further movement force on the moveable jaw in the direction of arrow 20, allows the moveable jaw to exert a clamping force on the workpiece so as to secure the same in position.

In the embodiment shown, the movement of the moveable jaw in the direction 20, is achieved by the provision of a ratchet mechanism between the track and the moveable jaw which allows the moveable jaw to be advanced in a stepwise manner when a foot pedal 24 is pivotally moved about pivot axis 22 of the apparatus. This movement is then transferred, via a lever arrangement, to drive the movement of the moveable jaw 8 in the direction 20 towards the fixed jaw. In order to release the moveable jaw 8 and allow the same to be moved in the direction 26 away from the fixed jaw, a release means 25 is provided for user operation which releases the drive and lever assembly between the foot pedal 24 and the moveable jaw 8 and allows the moveable jaw to be manually moved in the direction 28. When the workpiece is held in the clamped position then work can be performed on the same by the user using a suitable tool or tools which may be manually moved with respect to the apparatus or may be powered.

FIG. 2 illustrates the apparatus in a second mode of use in which the same is adapted to allow a power tool, in this case in the form of a mitre saw 30, to be securely located in position with respect to the body 12.

In both modes, the body is located at a spaced distance from a support surface 28 such as a floor, by the provision of legs 32 which, in one embodiment, can be moved between the in-use position shown and a storage position in which the same are folded and lie substantially in line with the body. Typically, the distance between the body and the support surface when the legs are in the in use position, is such as to allow the user to operate the power tool with their hands at a comfortable and convenient height.

The apparatus is adapted in accordance with the invention by the provision of support means which, in this embodiment, are provided in the form of first and second support arms 34,36 which are selectively located at a spaced distance apart along the longitudinal axis 18 of the body 12 and are secured thereto. The particular spacing between the support arms 34,36 is typically determined by the size of the power tool 30 and in particular, the specific location of engagement means apertures 40 provided on the power tool base. The support arms can therefore be located to ensure that each of the support arms will engage with at least one, or a plurality of the engagement apertures 40 on the power tool.

As illustrated in FIG. 4a, the support arms 34, 36, one of which is shown, are formed as an elongate member with apertures 42. The apertures 42 can be slotted, as illustrated, in order to allow the same to be range taking with respect to the position of the engagement means, which may also be apertures 40, which are provided on the particular power tool which is to be engaged with the support arms at a particular time. Thus, it will be appreciated that the same support arms may be used to engage with different types of power tool engagement means and/or with power tools of different types and sizes, and thereby allow the engagement in a fixed position of a selected power tool on the body.

An engagement of the power tool with one of the support arms 34 is illustrated in FIG. 4b, which shows part of the support arm and base of the power tool 30. To ensure engagement with the power tool and each support arm, a bolt 44 is passed through each of the engagement means apertures 40 in the base of the power tool 30 and then passed through the slotted aperture 42 in the support arm 34 at the position underlying the engagement means aperture 40 and receives thereon a nut 45 which is tightened so as to secure the support arm 34 to the power tool 30. This is then repeated for each of the apertures 40 provided on the power tool at respective positions on the support arms 34, 36.

The support arms 34 36 also include first and second retaining portions 46,48 which are shaped to allow retention of the support arms on the body 12. In this embodiment the retention portions are located at opposing end walls of, and define therebetween, a space 50, in which the body is located when the apparatus is in the second mode of use. The length of said space 50 is defined by the retaining portions and can be selected to suit, typically, the width of the body of the apparatus and across which the support arms are to be mounted.

Typically, to fit the support arm, the same is placed onto the body such that the body lies in the space and the longitudinal axis of the support arm is substantially perpendicular to the longitudinal axis of the body. At least one of the retaining portions 48 is provided such that when the support arm is located on the body the user can operate a user actuation means 60 which is connected to the retaining portion via a lever mechanism which passes along the support arm interior. The movement of the actuation means 60, as indicated by arrow 62, causes movement of the lever mechanism and in turn movement of the retaining portion 48 in order to move the retaining portion as indicated by arrow 64 towards the body and attempt to reduce the length of said space and thereby further increase the retaining force of the support arm in engagement on the body. In one embodiment one or both of retaining portions may be formed with contact faces with the body such that when in the retaining position, the contact faces are shaped to further enhance the engagement of the support arms on the body. The support arms are then engaged in a fixed position with the body.

In one embodiment the user can select the spacing of the support arms as appropriate and engage the support arms in those positions on the body and then engage the power tool on the support arms as illustrated in FIG. 3b. Alternatively, the user can first engage the support arms to the base of the power tool so that the support arms and power tool effectively form an integral unit and then locate and engage the support arms to the body with the power tool already retained in position with the support arms.

Although it is envisaged that the power tool 30 will typically be first engaged with the support arms before the support arms are attached to the body 12 so that the power tool 30 and support arms 34, 36 are effectively an integral unit, only the support arms are shown in FIG. 3b for ease of illustration. The support arms 34 and 36 are then introduced on top of the body 12 at the required spacing apart and the first retaining portion 46 is located at the side wall 52 of the body and when the same are in position, the second retaining portion 48 of each support arm is located on the side wall 54 of the body 12. The support arms are designed so that the body fits into the space 50 between the retaining portions 46, 48 in a snug manner and the operation of user actuation means 60 allows the retaining portion 48 of each of the support arms to increase the retaining force by moving the same towards the wall 54 of the body.

When the support arms 34, 36 are in position with the power tool located thereon as illustrated in FIG. 1b, the second mode of use of the apparatus is achieved.

To move the apparatus from the first mode of operation shown in FIG. 1 and FIG. 3a to the second mode of operation of FIGS. 2 and 3b, then, if necessary, the movable jaw can be released from being driven towards the fixed jaw and manually moved in the direction 28 to leave a gap X into which the support arms 34, 36 and power tool 30 are to be located.

There is therefore provided in accordance with the invention apparatus which can be used in two modes of operation and the adaptation of the apparatus can be relatively quickly achieved and without the need for any skilled person's intervention. As a result, apparatus which already has significant utility options to the user when in the first mode can now be provided with further functionality to allow the safe and accurate location of power tools therewith.

1. Apparatus for use in the performance of work on a workpiece, said apparatus including a plurality of legs depending from a body so that, the body is supported at a fixed distance from a support surface with which the legs contact, said body elongate in form and including a moveable jaw so that, in a first mode of use of the apparatus, said moveable jaw is selectively positioned along said body to define a space between the said moveable jaw and another jaw at or adjacent to one end of the said body and into which space the workpiece is received so as to be clamped in position between said jaws and wherein said apparatus includes one or more support means and said apparatus is adaptable to a second mode in which said one or more support means are engaged with the said body so as to define a support for the location of a power tool which, when located with the support means is supported in a fixed position so as to be used to perform a work operation on said workpiece.

2. Apparatus according to claim 1 wherein the said one or more support means are selectively engageable with the body of the apparatus so as to allow the same, when placed in position with the body, to support the power tool thereon and removed from the body when the same are not required to be used.

3. Apparatus according to claim 1 wherein the apparatus is operable to clamp the workpiece when the said at least one support means are removed and/or when the support means are in position with respect to the body.

4. Apparatus according to claim 1 wherein the one or more support means are provided in the form of first and second support arms locatable on the body at spaced apart locations along a longitudinal axis of the said body.

5. Apparatus according to claim 4 wherein the said spaced locations are selectable by the user with respect to the engagement portions formed on the power tool which are to be engaged with the respective support arms.

6. Apparatus according to claim 5 wherein the engagement portions on the power tool, are a series of apertures for the receipt of engagement means which pass through the said apertures and into location with the support arms.

7. Apparatus according to claim 6 wherein the said apertures in the power tool and/or provided on the support arms, are slotted so as to allow the same to be range taking and thereby allow different sizes of power tools to be engaged using the support arms.

8. Apparatus according to claim 7 wherein the apertures provided on the support arms enable the selective spacing of the support arms on the body of the apparatus.

9. Apparatus according to claim 1 wherein each of the support means includes a first retaining portion which is provided to locate and engage with a first part of the body and a second retaining portion provided to engage with a second part of the body.

10. Apparatus according to claim 9 wherein said first and second retaining portions define a recessed part of the support means in which part of the body and/or track are located when the support means is engaged therewith.

11. Apparatus according to claim 9 wherein the said first and second parts are first and second opposing side walls of the body.

12. Apparatus according to claim 1 wherein the support means include a user-actuable portion which, when operated, further increases the retaining force of the support means on the said body and the user actuable portion is operated by the user once they have selected the appropriate position of the support means on the body so as to secure the support means and power tool connected thereto in position on the body.

13. Apparatus according to claim 1 wherein the power tool is engaged with the support means and then the support means are engaged with the body of the apparatus.

14. Apparatus according to claim 1 wherein the movable jaw is mounted on a track formed in the body and is slidingly movable along said body and the other jaw is provided in affixed position on said body.

15. Apparatus according to claim 1 wherein the apparatus includes a foot pedal lever assembly which is pivotally movable by the user to advance the said moveable jaw towards the fixed clamping jaw and a release means which, when operated allows manual movement of the moveable clamping jaw away from the fixed clamping jaw.

16. Apparatus according to claim 1 wherein the power tool is used in a fixed or stationary position and includes any of a mitre saw, bench top power tool, sander tool, sharpener tool or the like.

17. A method for performing work on a workpiece using support apparatus to secure in position either the workpiece on which the work is to be performed or a power tool which is to perform the work on the workpiece, said support apparatus including a body portion, a moveable jaw which is moveable in relation to another jaw at or adjacent to an end of the body portion, one or more support means for the selective engagement of a power tool thereon and wherein said method includes the step of adapting the apparatus between a first mode of operation in which the workpiece is clamped in position between said jaws by the selective movement by the user of the moveable jaw towards and away from the other jaw to define a space therebetween in which the workpiece can be positioned and advancing the moveable jaw towards the other jaw to exert a clamping force on the workpiece and a second mode of operation, by locating the power tool with one or more said support means prior to or after locating said support means on said body, so as to engage the support means to the body and the power tool in a fixed position with respect to said body to allow the power tool to then be operated to perform work on a workpiece.

18. A method according to claim 17 wherein the support means includes at least first and second support arms and locating the first support arm at a first location on the said body and the second support arm at a second location on the said body, spaced from the first support arm.
